(19) United States
(12) Patent Application Publication
(10) Pub. No.: US 2015/0169064 A1
(43) Pub. Date: Jun. 18, 2015

(54) AVIONIC SYSTEM COMPRISING A HAPTIC INTERFACE

(71) Applicant: THALES, Neuilly Sur Seine (FR)

(72) Inventors: Stephanie LAFON, Merignac (FR); Francois MICHEL, Saint Medard en Jalles (FR); Sebastien DUMAY, Brach (FR)

(21) Appl. No.: 14/576,174

(22) Filed: Dec. 18, 2014

(30) Foreign Application Priority Data
Dec. 18, 2013 (FR) 1302975

(51) Int. Cl. G06F 3/01

(52) U.S. Cl. CPC G06F 3/016

(57) ABSTRACT

The general field of the invention is that of display systems comprising a display device displaying a configuration comprising a plurality of graphical formats, a touch-sensitive surface comprising means arranged to provide a haptic sensation and means of designation of the said plurality of graphical formats. In the system according to the invention, at least one function of implementation of a first graphical format does not comprise any displayed graphical indication and is signalled solely by a haptic sensation dedicated to the said implementing function when the designation means are on the said first graphical format or in its immediate vicinity.

The field of the invention is that of Man-System Interaction, also called “IHS”, principally intended for avionic applications.

In modern cockpits, the instrument panel comprises large display screens. The latter are controlled by several computers and present information of various types having different graphical and semantic aspects.

The pilot or pilots must be able to act on the avionic system either by requesting particular displays or by adding, deleting, modifying or validating data. At present, these functions are provided by an interface of the WIMP (Windows, Icons, Menus and Pointing device) type. This type of interface comprises a particular display of interactive elements such as graphical buttons, dialog boxes or scrolling lists. It then suffices to interact directly on these elements by means of touch screens or graphical cursors controlled either by devices called “CCD” or “Cursor Control Device” or by avionic touch-sensitive surfaces or touchpads.

At present, it is possible to add onto a touch-sensitive surface a so-called “haptic” function making it possible to give a tactile sensation which is generally a vibration at a specified frequency and intensity. Interfaces are then produced which belong to the family of interfaces known as “post-WIMP”, which make it possible to interact in a more sophisticated manner any type of graphical element. The interaction is no longer limited to just the interfaces of the WIMP type. Haptic feedback on the operation of these sophisticated IHS makes it possible to refine the cognitive representation experienced by the user of this interactive environment. Thus, the patent application WO 01/23911 entitled “Method and apparatus for multi-dimensional data modelling and analysis using a haptic interface device” describes a device making it possible to improve the three-dimensional perception of geophysical data. The patent application WO 02/073587 entitled “Haptic interface for laptop computers and other portable devices” describes a device combining haptic effect and tactile effect in a touchpad of a portable computer.

In a certain number of applications, including the aeronautical field, the use of haptic controls makes it possible to replace or complete the usual graphical controls. In particular they make it possible to manage graphical information shown on large display surfaces known as “seamless” where the management of a graphical cursor able to travel over the whole of the display surface is not necessarily easy to provide.

More precisely, the invention relates to a display system comprising at least:
a display device displaying a plurality of graphical formats and;
means of designation of the said plurality of graphical formats comprising means arranged in such a way as to provide a haptic sensation; characterized in that at least one function relating to a first graphical format does not comprise any displayed graphical indication and is signalled solely by a haptic sensation dedicated to the said function when the designation means designate the said first graphical format or its immediate vicinity.

In other words, the display system comprises at least:
a configuration manager for different graphical formats, a configuration comprising displayed formats, masked formats and passive areas;
a display device displaying a configuration comprising a plurality of graphical formats;
designation means comprising means arranged in such a way as to provide a haptic sensation;
a controller of the man-system display interfaces forming the interface with the display device, the configuration manager and the designation means.

It is characterized in that at least one function relating to a first non-displayed graphical format or a passive area does not comprise any displayed graphical indication and is signalled solely by a haptic sensation dedicated to the said function when the designation means designate the said first non-displayed graphical format or the said passive area or its immediate vicinity, the said function being implemented by means of the controller of the man-system display interfaces, of the display device, of the configuration manager and of the designation means, the said function being one of detection, substitution or prohibition.

Advantageously, the designation means comprise a touchpad independent of the display device or a haptic mouse or a haptic joystick and a graphical cursor displayed on the screen of the display device and controlled by the said touchpad.

Advantageously, the designation means comprise a transparent touch-sensitive surface, mounted on the screen of the display device.

Advantageously, when a first graphical format masks a second graphical format and when the designation means touch or are in the vicinity of the said first graphical format, a specific haptic sensation is transmitted, different from the other haptic sensations transmitted by the system, the function being a function of substitution of the first graphical format by the said masked second graphical format.

Advantageously, the substitution of the first graphical format by the second format is carried out by a positioning of the designation means on the said first graphical format for a predetermined period of time.

Advantageously, the substitution of the first graphical format by the second format is carried out by a predetermined movement of the designation means on the said first graphical format.

Advantageously, when the first format masks a plurality of formats, a specific haptic sensation is transmitted, different from the other haptic sensations transmitted by the system, the function being at least a function of detection of the said plurality of masked formats.

Advantageously, when the first graphical format does not comprise any implementing function and constitutes a passive area and the designation means touch or are in the vicinity of the said first graphical format, a specific haptic sensation is transmitted and the graphical cursor is automatically sent out of the first graphical format, in its last direction of movement.

Advantageously, when the first graphical format does not comprise any implementing function and constitutes a passive area and the designation means touch or are in the vicinity of the boundaries of the said first graphical format, a specific haptic sensation is transmitted, different from the other haptic sensations transmitted by the system.

Advantageously, the different haptic sensations comprise either different vibration frequencies, or different vibration amplitudes, or different variations of vibration amplitude, or different durations.

The invention will be better understood and other advantages will become apparent on reading the following description given in a non-limiting way and referring to the appended figures among which:

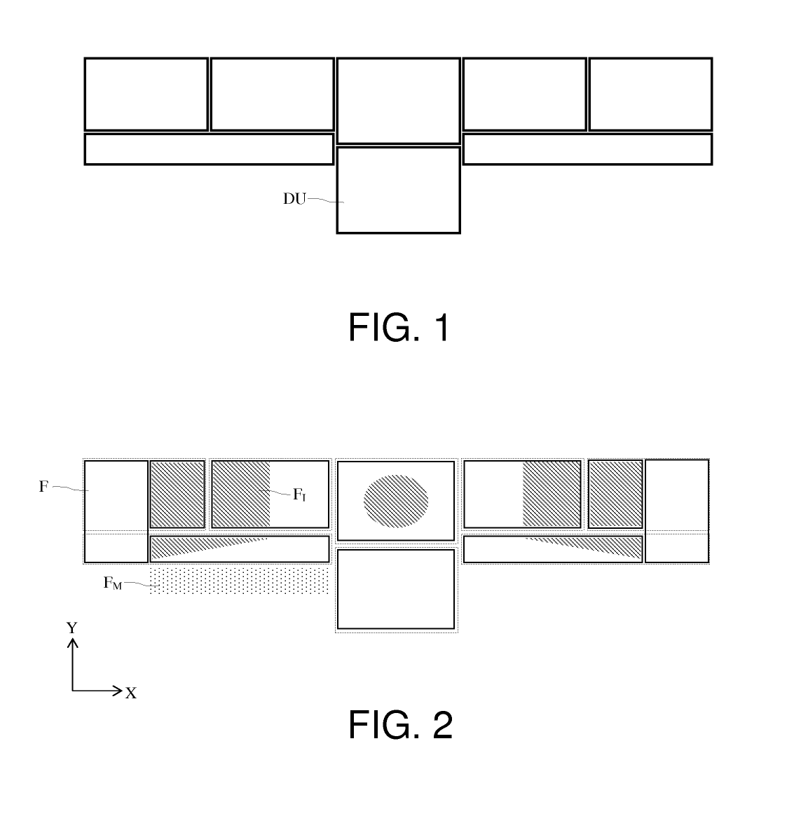

FIG. 1 shows the whole of the system of displays of the cockpit of an aircraft;

FIG. 2 shows, at a given time the configuration of the formats displayed on the said system of displays;

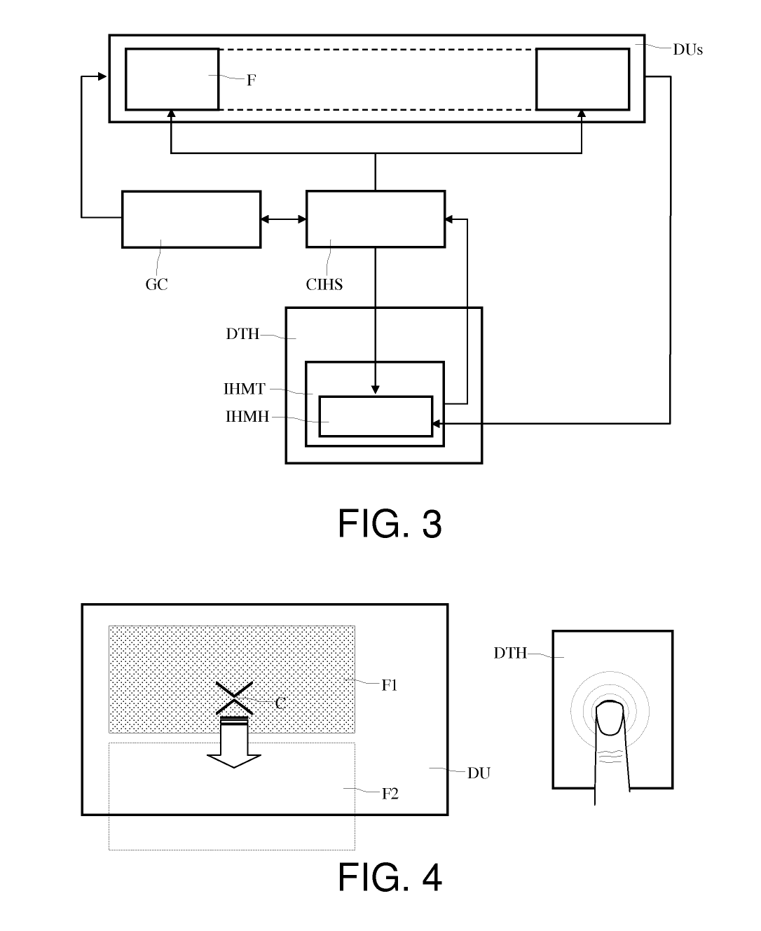

FIG. 3 shows a functional block diagram of the system of displays;

FIGS. 4, 5, 6 and 7 show four examples of implementation of the haptic means according to the invention.

By way of example, FIG. 1 shows the whole of the system of displays of the cockpit of an aircraft. In this example, the system comprises eight displays or “Displays Units” DU disposed in front of the crew members. Generally, the displays are liquid crystal devices.

FIG. 2 shows, at a given time, the distribution of image formats displayed on the preceding displays. The term “format” means a constituent area of the overall man-machine interface of the cockpit and dedicated to a particular application. This area has a graphical representation. In FIG. 2, each format is represented by a rectangle shown in thick black line. As can be seen in FIG. 2, the formats do not necessarily correspond to the size of the display screens. Thus, a format F can be displayed on two adjacent screens or can occupy only a part of a screen. Certain formats referenced F_{M} and represented in dotted lines in FIG. 2, represent “hidden” formats which can only be displayed when commanded. Other formats referenced F_{I} are so-called “prohibited” formats that the user cannot modify directly by the interaction means. For all of the formats, the coordinates of a displayed point M(x, y) are displayed in the reference system (X, Y) common to all of the formats.

FIG. 3 shows the functional block diagram of the display system according to the invention in the case where the designation means comprise a graphical cursor displayed on the screen of the display device controlled by a touchpad. A very similar diagram is obtained when the designation means comprise a haptic mouse or a haptic joystick. The designation means can also be transparent touchpads disposed on the display devices.

In this diagram, the arrows indicate the directions of the functional links or of the data transmissions. The whole of the display system comprises:
the set of display devices or “Displays Units” or DU displaying the different formats referenced in a reference system (x, y);
a configuration manager GC of the different formats;
a touch-sensitive and haptic device DTH comprising a touch-sensitive surface comprising touch recognition means IHMT and haptic sensation generating means IHMH. The touch-sensitive surface operates in relative coordinates, referenced DeltaX and DeltaY. Thus, the graphical cursor being positioned at a point M(x, y) on one of the formats, the movements performed by the user on the touchpad are represented by variations of the position of the cursor of value DeltaX and DeltaY;
a controller of the man-system interfaces or CIHS which forms the interface with the DUs, the configuration manager and the touch-sensitive and haptic device.

At all times, the CIHS knows the configuration of the display system, the types, the positions and the dimensions of the displayed formats and the applications represented by these formats. It also knows the position of the cursor. The principal functions of the CIHS are:
management of the graphical cursor as a function of information coming from the DTH: determination of its position in the different displayed formats, information to the formats of the presence of the graphical cursor;
management of the haptic functions as a function of the information delivered by the formats;
management of the configuration/reconfiguration requests to the GC.

The new functions for implementing the graphical formats according to the invention are carried out by means of the configuration manager GC, the touch-sensitive and haptic device DTH and the man-system interfaces controller or CIHS. These new functions are implemented by pieces of software dedicated to these different means.

The purpose of the invention is to carry out the different functions of implementing graphical formats without displayed graphical indication. Each function is signalled solely by a haptic sensation dedicated to the said implementation function when the designation means are on the said first graphical format or in its immediate vicinity.

The haptic sensation is due to a particular vibration of the touchpad. The different haptic sensations according to the invention comprise either different vibration frequencies, or different vibration amplitudes, or vibration amplitude variations varying for example by increasing or decreasing, or different durations. The haptic sensation can be localized at the position of the user's finger insofar as the touch-sensitive surface determines its position. It is also possible, if the user simultaneously places several fingers in contact with the touch-sensitive surface in order, for example to carry out a particular gesture, to develop different haptic sensations under each finger, as a function of the context and of the designated format.

As non-limiting examples, FIGS. 4, 5, 6 and 7 show four examples of implementation of the haptic means according to the invention. In these different figures, a partial view of a display system comprising a displayed format F and a cursor C represented by two letters V placed point-to-point, the white arrow indicating the direction of the action, has been shown on the left hand side and a touch-sensitive and haptic device DTH, the tactile sensation being represented by concentric circles in dotted line, has been shown on the right hand side.

FIG. 4 shows the implementation of the invention in the case of presence of a masked format. When a first graphical format F1 masks a second graphical format F2, if the cursor C touches or is in the vicinity of the boundaries of the first graphical format F1, a specific haptic sensation is transmitted, different from the other haptic sensations transmitted by the system, signalling to the user the presence of a second hidden format F2, the implementation function being a function of substitution of the first graphical format by the said second masked graphical format. By way of example, the “border area” for the use of this function represents either a constant percentage of the area of the first displayed format, or a border area of constant size.

The haptic sensation can be a vibration that is amplified from the appearance of the second format until the complete substitution of the first format by the second format if the user keeps the cursor in the border area for a sufficiently long time. This replacement or this reconfiguration is controlled by the CIHS. This reconfiguration can be definitive or temporary, allowing the appearance of the second format for a specific period of time. The substitution of the first graphical format by the second format can be provided by a predetermined movement of the designation means on the first graphical format. The validation of the replacement of the first format by the second can also require an additional operation by the user, like the validation by a “click” on a control button situated in the vicinity of the touch-sensitive surface. The reverse operation is of course possible and it is easily possible to return to the display of the first format. In fact, this haptic signal makes the interaction explicit without the addition of superfluous graphical symbols which necessarily take up space.

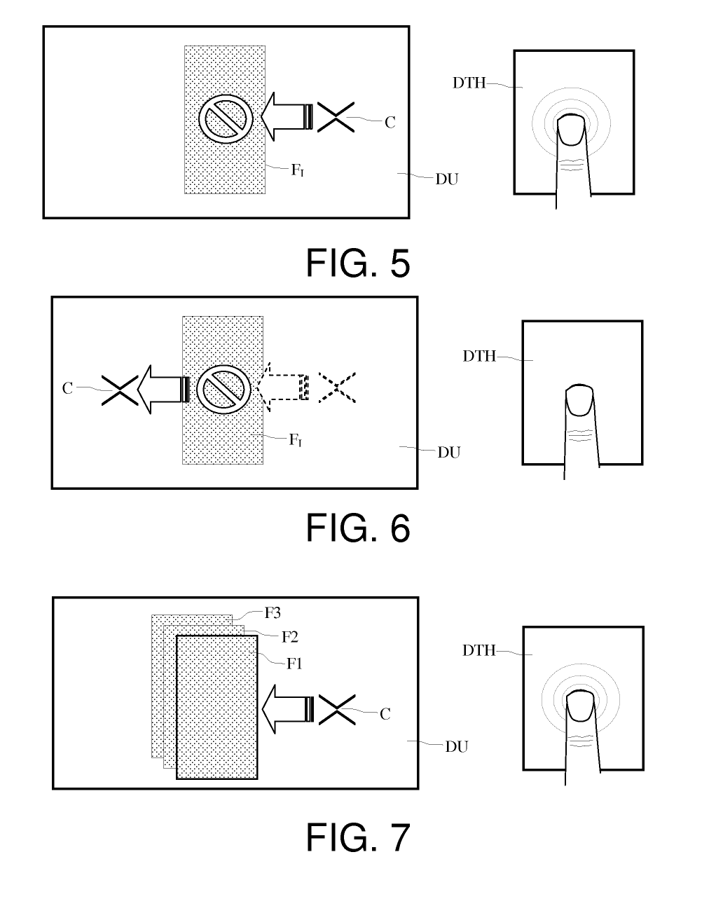

FIGS. 5 and 6 show the implementation of the invention in the case of presence of a “prohibited” format. The term “prohibited format” means an area where the cursor cannot have actions. The purpose of these areas is to protect data which must not be modified in an inopportune manner. In FIGS. 5 and 6, this area is indicated by a “no parking” sign. In this case, when the cursor C touches or is in the vicinity of the boundaries of the prohibited format F_{I}, a specific haptic sensation is transmitted. It is preferable that this haptic sensation should be unpleasant in order to discourage the user from entering this area. An unpleasant haptic sensation can be obtained by generating a periodic signal whose amplitude follows a sawtooth waveform, for example.

The graphical cursor can then be automatically sent outside of the first graphical format, in its last direction of movement as can be seen in FIG. 6, thus signalling to the user the presence of a prohibited area without the user wasting time by moving his cursor in an inactive area whose parameters cannot be changed. It is preferable to send the cursor in the direction of its last movement in order that the user can find it again easily, it being possible for the prohibited format to have large dimensions. The “jump” of the cursor out of the prohibited graphical format F_{I} can be accompanied by a haptic effect. The haptic signal can be modulated as a function of the distance travelled by the cursor so that the user can determine the order of magnitude of the length of the jump intuitively. It can also be accompanied by a fleeting trace allowing the user to follow it visually.

This user function thus makes it possible to reach the interactive areas more quickly whilst being aware of the cursor jumps. In fact, a particular and recognisable haptic signal makes it possible to understand that the disappearance of the cursor is desired and not erroneous. It is also possible to force the cursor to remain in a specific area situated between several prohibited formats. The DTH then retrieves the DeltaX and DeltaY values as a function of the topology of the area.

FIG. 7 shows the implementation of the invention in the case of presence of a plurality of superimposed formats. By way of example, these formats can represent the different pages of an item of documentation. In the case of FIG. 7, three formats are shown, referenced F1, F2 and F3. The first format F1 masks the other two. A specific haptic sensation is then transmitted when the cursor C touches or is in the vicinity of the visible graphical format F1, different from the other haptic sensations transmitted by the system, the implementation function being at least the detection of the said plurality of masked formats. It is also possible to vary the haptic sensation when the changing from one format to the other, as if running through the different formats, making it possible to select them and make them appear on the display screen. The haptic sensation makes it possible to become aware of numerical data, for example corresponding to skipping several pages, like when the operator turns a rotary control.

For greater efficiency, the haptic information can be accompanied by sound or visual information. The possibility of the cursor leaving a fleeting trace during its automatic movements has been mentioned by way of example.

1. Display system comprising at least:
a configuration manager for different graphical formats, a configuration comprising displayed formats, masked formats and passive areas;
a display device displaying a configuration comprising a plurality of graphical formats;
designation means comprising means arranged in such a way as to provide a haptic sensation;
a controller of the man-system display interfaces forming the interface with the display device, the configuration manager and the designation means;
wherein at least one function relating to a first non-displayed graphical format or a passive area does not comprise any displayed graphical indication and is signalled solely by a haptic sensation dedicated to the said function when the designation means designate the said first non-displayed graphical format or the said passive area or its immediate vicinity, the said function being implemented by means of the controller of the man-system display interfaces, of the display device, of the configuration manager and of the designation means, the said function being one of detection, substitution or prohibition.

2. Display system according to claim 1, wherein the designation means comprise a touchpad independent of the display device or a haptic mouse or a haptic joystick and a graphical cursor displayed on the screen of the display device and controlled by the said touchpad.

3. Display system according to claim 1, wherein the designation means comprise a transparent touch-sensitive surface, mounted on the screen of the display device.

4. Display system according to claim 1, wherein when a first graphical format masks a second graphical format and when the designation means touch or are in the vicinity of the said first graphical format, a specific haptic sensation is transmitted, different from the other haptic sensations transmitted by the system, the function being a function of substitution of the first graphical format by the said masked second graphical format.

5. Display system according to claim 4, wherein the substitution of the first graphical format by the second format is carried out by a positioning of the designation means on the said first graphical format for a predetermined period of time.

6. Display system according to claim 4, wherein the substitution of the first graphical format by the second format is carried out by a predetermined movement of the designation means on the said first graphical format.

7. Display system according to claim 4, wherein when the first format masks a plurality of formats, a specific haptic sensation is transmitted, different from the other haptic sensations transmitted by the system, the function being at least a function of detection of the said plurality of masked formats.

8. Display system according to claim 2, wherein when the first graphical format does not comprise any implementing function and constitutes a passive area and the designation means touch or are in the vicinity of the said first graphical format, a specific haptic sensation is transmitted and the graphical cursor is automatically sent out of the first graphical format, in its last direction of movement.

9. Display system according to claim 3, wherein when the first graphical format does not comprise any implementing function and constitutes a passive area and the designation means touch or are in the vicinity of the boundaries of the said first graphical format, a specific haptic sensation is transmitted, different from the other haptic sensations transmitted by the system.

10. Display system according to claim 1, wherein the different haptic sensations comprise either different vibration frequencies, or different vibration amplitudes, or different variations of vibration amplitude, or different durations.
